(19) United States
(12) Patent Application Publication
(10) Pub. No.: US 2024/0427834 A1
(43) Pub. Date: Dec. 26, 2024

(54) CONTEXT BASED TRANSLATION AND ORDERING OF WEBPAGE TEXT ELEMENTS

(71) Applicant: International Business Machines Corporation, Armonk, NY (US)

(72) Inventors: Yuan Jie Zhang, Ningbo (CN); Chao Yuan Huang, Taipei (TW); Yan Xiu Wu, Beijing (CN); Kevin Xin, Beijing (CN)

(73) Assignee: International Business Machines Corporation, Armonk, NY (US)

(21) Appl. No.: 18/212,038

(22) Filed: Jun. 20, 2023

(51) Int. Cl. G06F 16/958; G06F 40/103; G06F 40/47

(52) U.S. Cl. CPC G06F 16/972; G06F 40/103; G06F 40/47

(57) ABSTRACT

A computer-implemented method, according to one embodiment, includes determining a domain and category information from metadata associated with a first webpage. The method further includes determining component types, hierarchies and grouping relationships for a plurality of text elements on the first webpage and constructing context information for the text elements. Word vectors are calculated based on the grouping relationships and the context information, and text feature types of the text elements are extracted based on the word vectors and the context information. The method further includes using the extracted text feature types to determine a re-ordering of a translation of the text elements. A computer program product, according to another embodiment, includes a computer readable storage medium having program instructions embodied therewith. The program instructions are readable and/or executable by a computer to cause the computer to perform the foregoing method.

### BACKGROUND

The present invention relates to language translations, and more specifically, this invention relates to context based translation and ordering of webpage text elements.

The internet and the world-wide web have allowed people to enjoy shopping and communication all over the world while using a user device, e.g., such as a computer, while at their own desk. For example, a user using a user device may place an order for a product that is sold and shipped from a company that is on a different continent than the continent that the user is located at. While using such user devices to interact with one or more web-based experiences, users typically view content that is in more than one language.

### SUMMARY

A computer-implemented method, according to one embodiment, includes determining a domain and category information from metadata associated with a first webpage. The method further includes determining component types, hierarchies and grouping relationships for a plurality of text elements on the first webpage and constructing context information for the text elements. Word vectors are calculated based on the grouping relationships and the context information, and text feature types of the text elements are extracted based on the word vectors and the context information. The method further includes using the extracted text feature types to determine a re-ordering of a translation of the text elements.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A, in accordance with one embodiment of the present invention.

FIG. 2C is a flowchart of sub-operations of an operation of the flowchart of FIG. 2A, in accordance with one embodiment of the present invention.

FIG. 3 is an implementation structure, in accordance with one embodiment of the present invention.

FIG. 4 is a DOM tree, in accordance with one embodiment of the present invention.

FIGS. 5A-5B are context structures, in accordance with several embodiments of the present invention.

FIG. 6 is an I/O flowchart, in accordance with one embodiment of the present invention.

FIG. 7 is an I/O flowchart, in accordance with one embodiment of the present invention.

FIG. 8 is an I/O flowchart, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for context based translation and ordering of webpage text elements.

In one general embodiment, a computer-implemented method includes determining a domain and category information from metadata associated with a first webpage. The method further includes determining component types, hierarchies and grouping relationships for a plurality of text elements on the first webpage and constructing context information for the text elements. Word vectors are calculated based on the grouping relationships and the context information, and text feature types of the text elements are extracted based on the word vectors and the context information. The method further includes using the extracted text feature types to determine a re-ordering of a translation of the text elements.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as translation and ordering determination code of block 150 for context based translation and ordering of webpage text elements. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

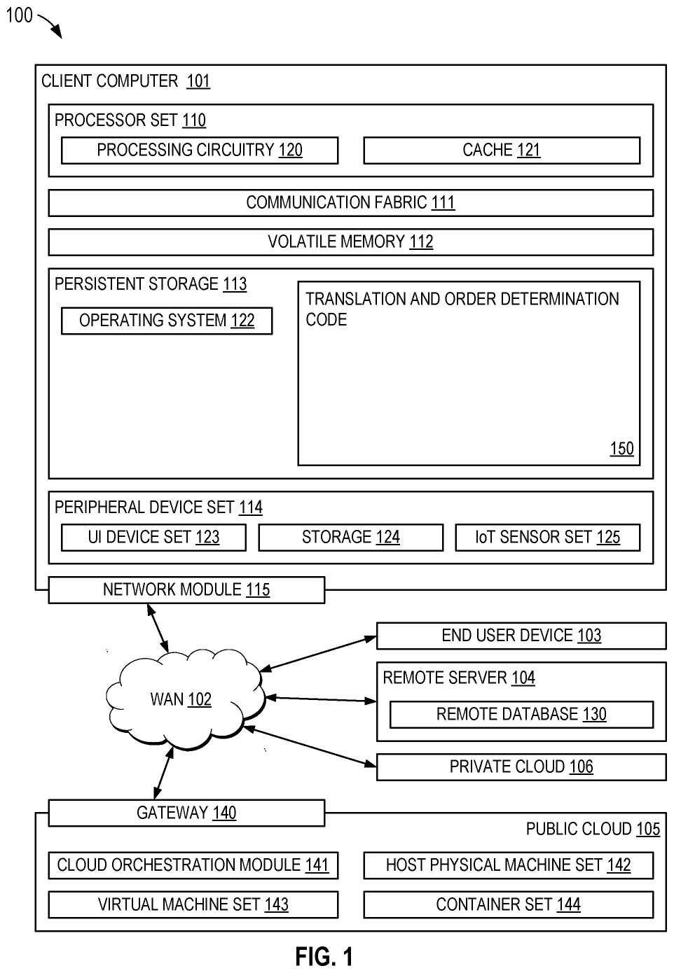

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, the internet and the world-wide web have allowed people to enjoy shopping and communication all over the world while using a user device, e.g., such as a computer, while at their own desk. For example, a user using a user device may place an order for a product that is sold and shipped from a company that is on a different continent than the continent that the user is located at. While using such user devices to interact with one or more web-based experiences, users typically view content that is in more than one language.

In order to understand web-based content that is in a language that is not the user's first language and/or not a language that the user understands, conventional translation tools are sometimes used by users. Conventional online translation tools are sometimes useful to establish a rough idea of the meaning of the content of a website, however, the quality of the translation is ultimately not accurate enough to be posted on the websites themselves. These tools often translate the content of a website word for word, or sentence for sentence, but do not account for the context of the website contents. Accordingly, the translated content output by these conventional tools is often confusing for the user. With the increase of globalization, it has become imperative for organizations to provide web site content in multiple languages in relatively high-quality. Accordingly, there is a longstanding need for techniques for translating web-based text, where an order of text elements in the translation is determined based on domain and contextual information of a website.

In sharp contrast to the deficiencies of the conventional translation techniques described above, various embodiments and approaches described herein include webpage auto-translation techniques that are based on web page metadata analysis. For example, these techniques introduce context information of text elements on a webpage, in addition to techniques for gathering text elements context information by analyzing web page metadata. More specifically, these techniques include obtaining web page business domain and category information from web page metadata, and obtaining component types, hierarchies and grouping relationships of text elements from webpage metadata. Context information is constructed for the text elements, e.g., business domain, category, component type, parent and group, etc. Furthermore, these techniques include calculating word vectors with grouping and context information of the text elements from a word embeddings model. Text feature types are extracted based on the text element word vectors and context information, and the text elements are translated and re-ordered by text elements groupings. A translation model may be trained based on text elements context information and thereafter be configured to generate and/or perform word embeddings, text feature type extraction, text translation and re-ordering of text.

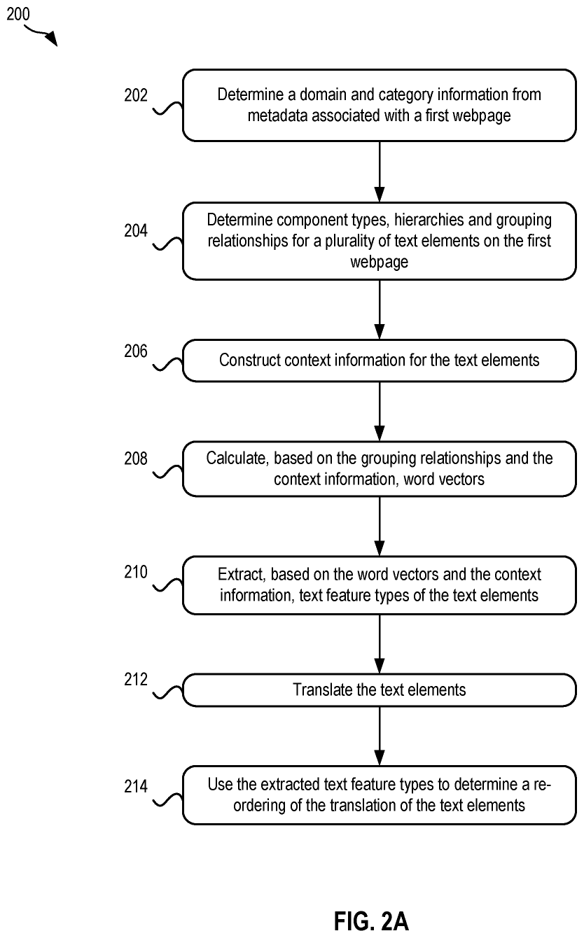

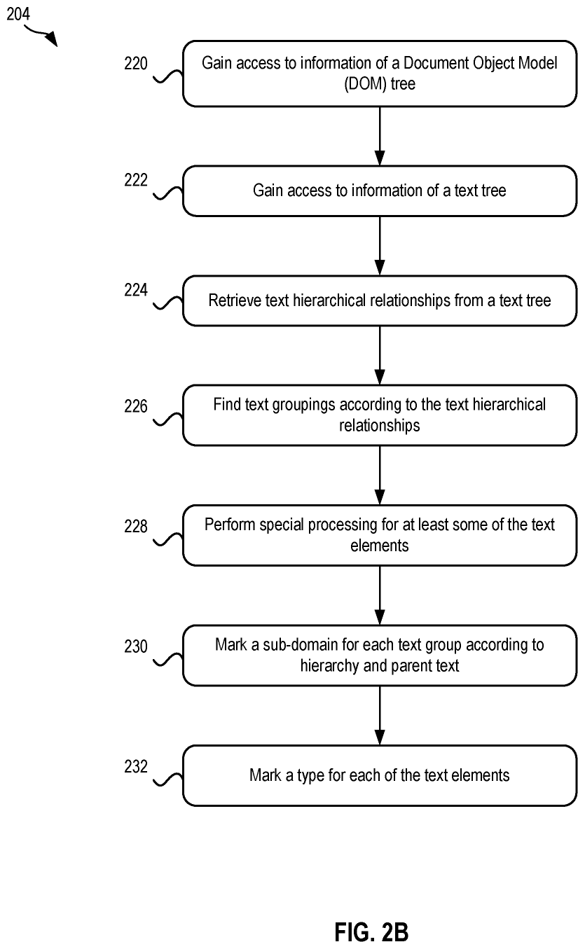

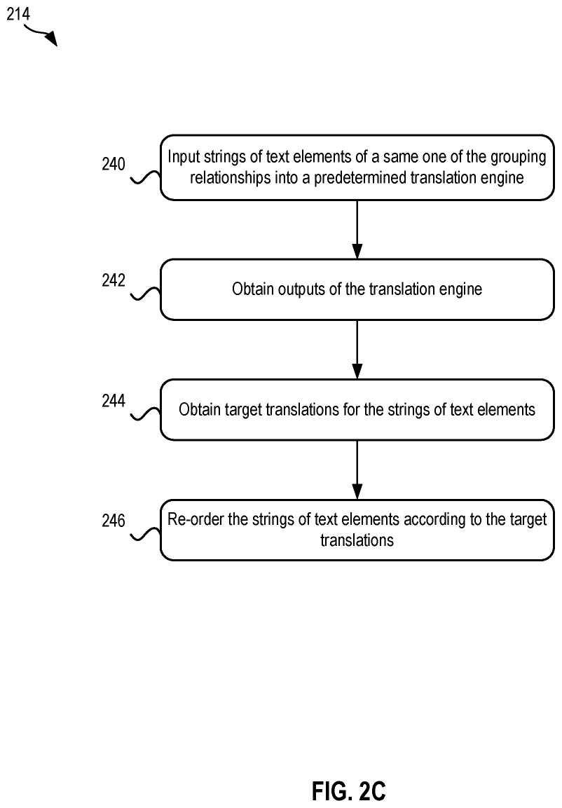

Now referring to FIG. 2, a flowchart of a method 200 is shown according to one embodiment. The method 200 may be performed in accordance with the present invention in any of the environments depicted in FIGS. 1-8, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, method 200 includes techniques for contextually translating the contents, e.g., text elements, of a webpage. In some approaches, the text elements are words, characters, symbols, etc., of the webpage, which may be displayed on a user device, e.g., such as a computer with web-browsing capabilities, that accesses the webpage. In some approaches, one or more of the operations of method 200 may be performed in response to receiving a selection that corresponds to an option to turn on translation features of the user device. In other words, in at least some of such approaches, the contextual translation features may be selectively applied and turned-off, in response to receiving a request to do so. In some other use cases, the techniques described herein may be applied to a server that hosts the webpage. For example, in some approaches, a request may be received from a client device associated with a business that owns the webpage. Such a request may specify that the contextual translation features described herein are to be applied to text elements of the webpage. It should also be noted that the techniques described herein may be applied to correctly translate any first language to any second language.

Operation 202 includes determining a domain and category information from metadata associated with a first webpage. In some approaches, the first webpage is associated with a first business, e.g., moderated by a user device used by an employee of the first business, a homepage of the first business, an order site for products produced by the first business, etc. The first webpage preferably includes at least some content that is to be translated. For example, in some preferred approaches, the first webpage includes text elements, e.g., words, that are in a first language and that are to be translated to a predetermined second language, e.g., a language understood by a user using a user device that is determined to be accessing the first webpage.

In some approaches, the domain and category information are determined by analyzing a predetermined target that is determined from the metadata. In at least one of such approaches, the predetermined target that is analyzed includes a uniform resource locator (URL) that is associated with the webpage. For example, in some approaches, a type of URL analysis, that would become apparent to one of ordinary skill in the art after reading the descriptions herein, may be used to determine the domain and category information. In one of such approaches, a domain registry may be used to find a domain in which the URD domain resides. In another approach, a search engine may be used to find a URL path of the first webpage and obtain the webpage basic category by the search result. In some other approaches, the predetermined target that is analyzed may additionally and/or alternatively include head information. For example, in one or more of such approaches, the head information may specifically be used to find a domain of the first webpage, e.g., via a head/title, head description metadata text, etc. In yet some other approaches, the predetermined target that is analyzed may additionally and/or alternatively include a navigator, e.g., a navigator element. In one or more of such approaches, the navigator element may be found at one or more search locations, e.g., a navigation location, a sidebar of the webpage, a header of the first webpage, etc. In another approach, the navigator element may be identified as a selected option of the first webpage.

Operation 204 includes determining component types, hierarchies and grouping relationships for a plurality of text elements on the first webpage. In some approaches, the component types, hierarchies and grouping relationships are only determined for text elements that are determined to be incorporated into the translation. In other words, in some approaches, a plurality of the text elements may be identified to already be in the second language and therefore excluded from the determination in order to preserve processing potential. In contrast, in some other approaches, all of the text elements are included in the determination.

The component types, hierarchies and grouping relationships are, in some approaches, determined from the metadata associated with the first webpage. Furthermore, the grouping relationships and context information may, in some approaches, be determined using a predetermined word embedding model. In yet some other approaches, the natural language processing (NLP) may be applied to analyze article structure, which the component types, hierarchies and/or grouping relationships may be based on. An illustrative approach that details a sub-process of determining the grouping relationships and context information using a predetermined word embedding model is described below.

Looking to FIG. 2B, exemplary sub-operations of determining component types, hierarchies and grouping relationships for a plurality of text elements on the first webpage are illustrated in accordance with one embodiment, one or more of which may be used to perform operation 204 of FIG. 2A. However, it should be noted that the sub-operations of FIG. 2B are illustrated in accordance with one embodiment which is in no way intended to limit the invention.

Sub-operation 220 includes gaining access to information of a document object model (DOM) tree. In some approaches, the DOM tree may be obtained using techniques that would become apparent to one of ordinary skill in the art after reading the descriptions herein. The DOM tree may, in some approaches, be used to obtain a text tree associated with the first webpage. For example, sub-operation 222 includes gaining access to information of a text tree. One or more of these trees may be predetermined and/or associated with the first webpage and thereby include information that is associated with the first webpage. For example, in some approaches, text elements are extracted from the text tree.

Sub-operation 224 includes retrieving text hierarchical relationships from the text tree. The text hierarchical relationships may include relationship information of a type that would become apparent to one of ordinary skill in the art after reading the descriptions herein. For example, the text hierarchical relationships may include, e.g., child text node information, parent text node information, etc.

Text groupings may be found according to the text hierarchical relationships, e.g., see sub-operation 226. For example, in some approaches, child text nodes are grouped together in a first text grouping. In another approach, a second text grouping may include parent text nodes that are grouped together.

Special processing may be performed for at least some of the text elements, e.g., see sub-operation 228. For example, in a table, elements may be grouped under each predetermined table header, e.g., typically where a column defines a group. A sub-domain may be marked for each text group according to hierarchy and parent text, e.g., see sub-operation 230. For example, the marking may be made for heading text, obvious category information, e.g., such as page title and/or subtitle, etc. Based on these markings, a type for each of the text elements may be marked, e.g., see sub-operation 232, which may be used in further analysis, e.g., that considers text feature types as will be described elsewhere herein. For example, these types may in some approaches, e.g., indicate whether the text element belongs to a list, the text element is a table header, etc.

With reference again to FIG. 2A, method 200 includes constructing context information for the text elements, e.g., see operation 206. In some approaches, the context information includes a business domain of a given text element. In another approach, the context information may additionally and/or alternatively include a category of a given text element. In yet another approach, the context information may additionally and/or alternatively include a component type. The context information may additionally and/or alternatively include a parent of a given text element. In yet another approach, the context information may additionally and/or alternatively include a group of the text element. In some preferred approaches, the constructed text information may include a plurality of the context information examples detailed above.

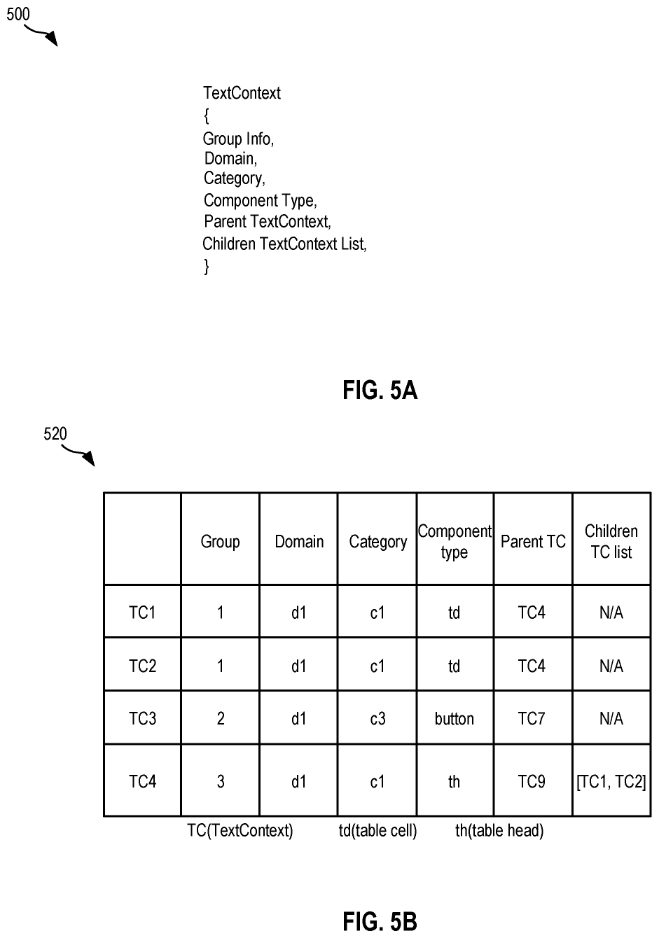

In some preferred approaches, a predetermined text element context information constructor may be caused to collect all the context information, e.g., business domain, category, component type, hierarchy, group, etc., from a DOM tree elements analyzation module and then build the translation data structure based on the collected context information. Illustrative examples of context information structures are described in greater detail elsewhere below, e.g., see FIGS. 5A-5B.

Operation 208 includes calculating word vectors. In some preferred approaches, the word vectors are calculated based on the grouping relationships of the text elements and the constructed context information. In some approaches, calculation of the word vectors includes performing a predetermined process. For example, the predetermined process may, in some approaches, include inputting some strings in the same group with domain, category, type and other information in a predetermined type of vector calculator. The predetermined type of vector calculator may be of a type that would become apparent to one of ordinary skill in the art after reading the descriptions herein. The predetermined process may additionally and/or alternatively include calculating each string vector candidate values. Furthermore, the predetermined process may additionally and/or alternatively include choosing group vector values which have same dimension features.

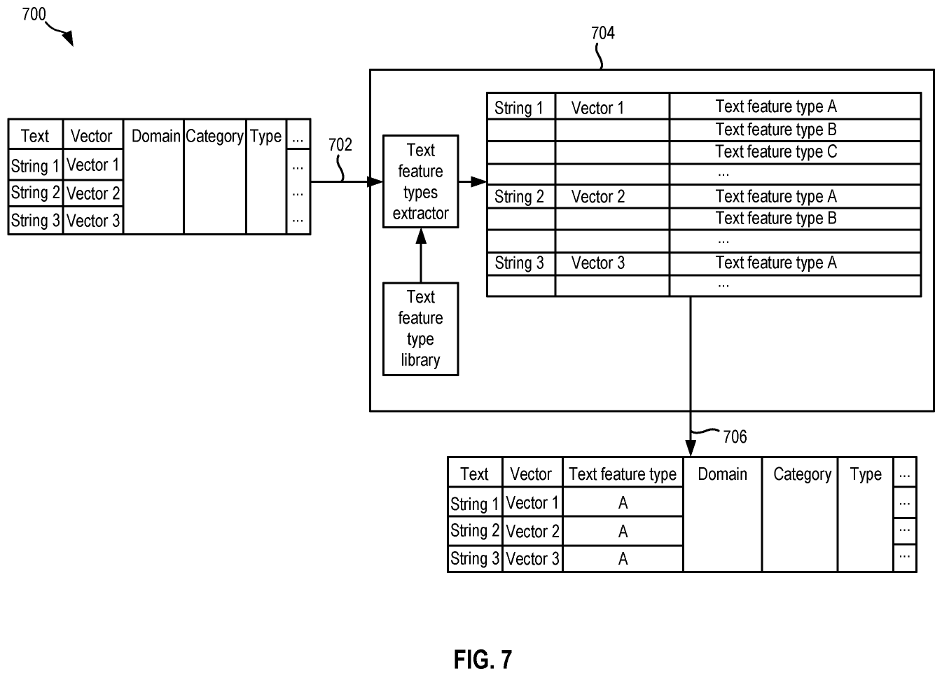

Operation 210 includes extracting, based on the text element word vectors and the context information, text feature types of the text elements. In some approaches, the text feature types may include, e.g., whether a word is a verb, whether a word is a noun, whether a word is an adjective, etc. In some preferred approaches, the extraction of the text feature types of the text elements is performed using a predetermined process. In one or more of such approaches, the predetermined process includes inputting some strings in the same group with vector, domain, category, type and other information, into a predetermined text feature type extractor model. In some approaches, the predetermined text feature type extractor model may be of a type that would become apparent to one of ordinary skill in the art after reading the descriptions herein. The predetermined process may additionally and/or alternatively include calculating each string text feature candidate types, and choosing a group text feature type based on group domain, category, type and other information. Further illustrative examples of extracting the text feature types of the text elements are described in greater detail elsewhere below, e.g., see FIG. 7.

Operation 212 includes translating the text elements from the first language to the second language. In some approaches, a known type of text translation may be performed on the text elements. Once translated, the translation of the text elements is preferably reordered, e.g., see operation 214. In some approaches, the text elements are preferably reordered based on a context determined in one or more of the operations described above. For example, in one preferred approach, the extracted text feature types are used to determine a re-ordering of a translation of the text elements. In some approaches, this context and text elements may be applied to a predetermined plurality of linguistic rules for the second language to determine one or more of the re-ordering operations to perform.

Looking to FIG. 2C, exemplary sub-operations of using the extracted text feature types to determine the re-ordering of the translation of the text elements are illustrated in accordance with one embodiment, one or more of which may be used to perform operation 214 of FIG. 2A. However, it should be noted that the sub-operations of FIG. 2C are illustrated in accordance with one embodiment which is in no way intended to limit the invention.

In some preferred approaches, the translation and re-ordering of the text is based on the text elements groupings. For example, sub-operation 240 includes inputting strings of text elements of a same one of the grouping relationships into a predetermined translation engine. In some approaches, the strings that are input may include matching information associated therewith, e.g., are in the same group, are in the vector, have a same text feature type, have other matching context information, etc. Furthermore, in some approaches, the strings may be input into the predetermined translation engine with the information, e.g., information about the word vectors, an indication of text feature types, and associated portions of the context information, etc. Outputs of the translation engine are obtained, e.g., see sub-operation 242. In some approaches, the outputs may include target vectors that are calculated for the strings of text elements. Sub-operation 244 includes obtaining, from a predetermined linguistic engine that is configured to incorporate and use the context, target translations for the strings of text elements. The strings of text elements are then re-ordered according to the target translations, e.g., see sub-operation 246. This re-ordering thereby adjusts a pattern of the text sentence.

With reference again to FIG. 2A, in some approaches, the method 200 may optionally include training a predetermined translation model based on the context information to perform a context based re-ordering of translated text elements. The predetermined translation model may, in some approaches, be an artificial intelligence (AI) model. In some approaches, the model is trained to process word embeddings, text feature type extraction, text translation and/or to perform a re-ordering of text of a webpage. For example, the operations of method 200 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to use the extracted text feature types to determine a re-ordering of a translation of text elements. Initial training may include reward feedback that may, in some approaches, be implemented using a subject matter expert (SME) who generally understands such a re-ordering based on having access to answers of the training dataset. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some further approaches, the AI model may be a neuromyotonic AI model that may improve performance of computer devices in an infrastructure associated with determining contextual based re-orderings of translations of web-based text elements, because the neuromyotonic AI model may not need a SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from a predetermined analysis engine. Such an AI model ensures that the resulting translation incorporates a determined context that is lacking in conventional machine based translations, where the scale of such analysis and determinations would not otherwise be feasible for a human to perform. This is because humans are not able to efficiently perform web-based translations while determining and considering contexts associated therewith, and would otherwise incorporate processing delays and errors in the re-ordering of translated text elements in the process of attempting to do so. Accordingly, management of operations described herein is not able to be achieved by human manual actions.

The trained translation model may, in some approaches, be caused, e.g., instructed, to perform a context based re-ordering of text elements translated from a second website.

Various benefits are enabled as a result of using the techniques described herein to translate text elements. For example, translation quality is relatively improved for a structured web page that includes the text elements that are translated. This is because conventional translation tools often translate the content of a website word for word, or sentence for sentence, but do not account for the context of the website contents. Translation quality is also improved for the structured article, e.g., using NLP technology to analyze article structure. This analysis is not otherwise inspectable by a human and is ultimately not considered whatsoever by conventional word for word translation tools. Translation quality is also improved for a structured translation resource using the techniques described herein.

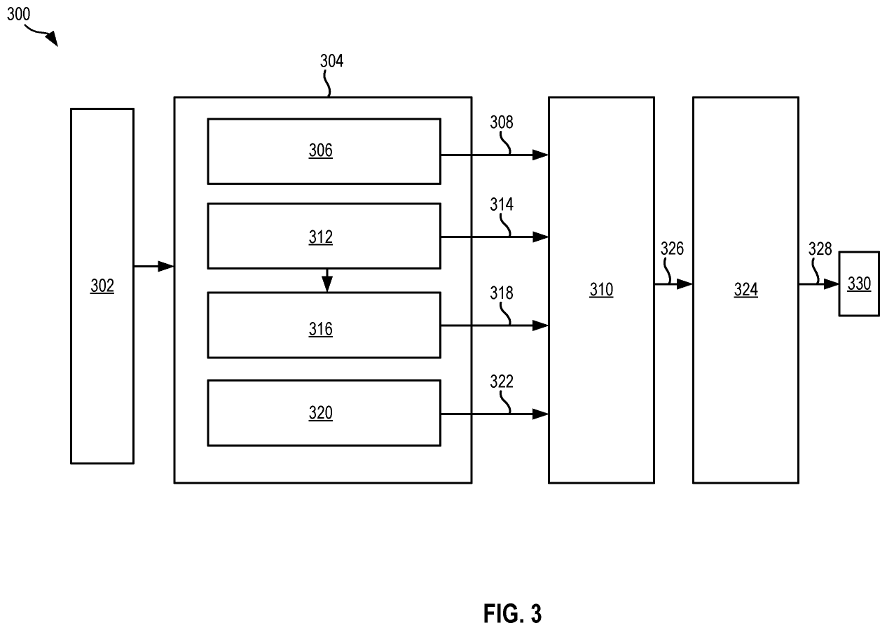

FIG. 3 depicts an implementation structure 300 for contextually translating web-based text elements, in accordance with one embodiment. As an option, the present structure 300 may be implemented in conjunction with features from any other embodiment listed herein, such as those described with reference to the other FIGS. Of course, however, such structure 300 and others presented herein may be used in various applications and/or in permutations which may or may not be specifically described in the illustrative embodiments listed herein. Further, the structure 300 presented herein may be used in any desired environment.

The structure 300 includes a plurality of modules that are preferably configured to perform at least some of the operations of method 200 described elsewhere above. For example, the structure 300 includes a first module 302 that is caused to load a HyperText Markup Language (HTML) on a (UI). DOM tree elements associated with the HTML may be analyzed by a second module 304. The second module 304 includes a plurality of components that are each configured to be caused to analyze the DOM tree elements. For example, a UI construct identification component 306 is configured to determine a domain and/or category from the DOM tree elements, and output the determined domain and/or category to a text elements contextualized information constructor module 310, e.g., see output operation 308. Furthermore, a UI content hierarchy generator component 312 is configured to determine parent content from the DOM tree elements, and output the determined parent content to the text elements contextualized information constructor module 310, e.g., see output operation 314, and/or output the determined parent content to a UI content grouping constructor component 316. The UI content grouping constructor component 316 is configured to determine groupings of content from the DOM tree elements, and output the determined groupings to the text elements contextualized information constructor module 310, e.g., see output operation 318. Furthermore, a UI component type identification component 320 is configured to determine component types from the DOM tree elements, and output the determined component types to the text elements contextualized information constructor module 310, e.g., see output operation 322.

The text elements contextualized information constructor module 310 is configured to use the outputs of the second module 304 to determine contextualized information that is input into a translation module 324, e.g., see operation 326. The translation module 324 is configured to use the contextualized information to re-order text elements of a translation 330 that is output for display on a predetermined graphical user interface, e.g., see operation 328.

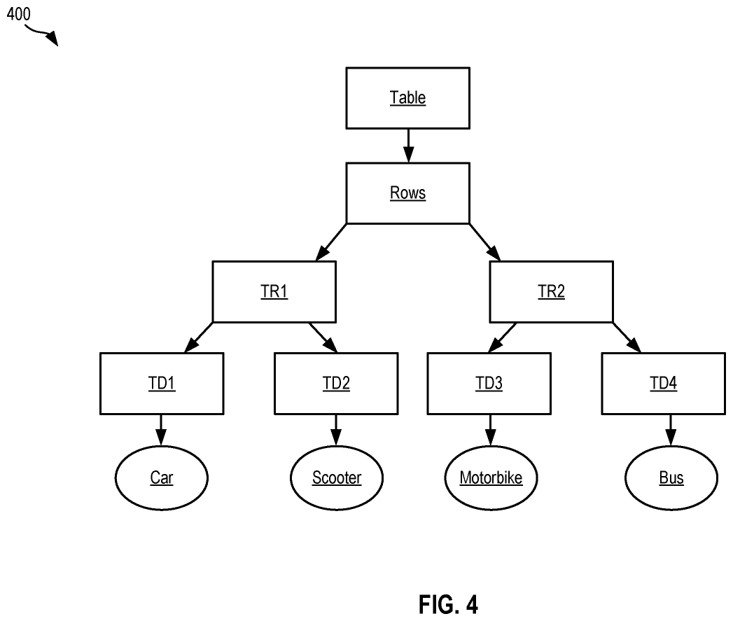

FIG. 4 depicts a DOM tree 400, in accordance with one embodiment. As an option, the present DOM tree 400 may be implemented in conjunction with features from any other embodiment listed herein, such as those described with reference to the other FIGS. Of course, however, such DOM tree 400 and others presented herein may be used in various applications and/or in permutations which may or may not be specifically described in the illustrative embodiments listed herein. Further, the DOM tree 400 presented herein may be used in any desired environment.

The DOM tree 400 includes information of a table, e.g., see Table, that is broken down into sub-parts of the tree structure. For example, the table may be broken down into rows, e.g., see Rows, that are defined by a first branch, e.g., see TR1, and a second branch, e.g., see TR2. The branches thereafter split into a plurality of cells, e.g., see TD1, TD2, TD3 and TD4, that may be arranged in columns. Each of these cells include an associated text element, e.g., see “Car” of TD1, “Scooter” of TD2, “Motorbike” of TD3 and “Bus” of TD4. Text elements of cells in the same column positioned in each of the branches may be grouped together. For example, in the current DOM tree, the text element “Car” may be grouped with the text element “Motorbike” and the text element “Scooter” may be grouped with the text element “Bus”. These groupings may be used as contextual information in an analysis that defines how to re-order a translation of the text elements, e.g., using the analysis techniques described in method 200.

In some other approaches, in a multi-level DOM tree, text elements in the same level may optionally be grouped together to establish the contextual information.

FIGS. 5A-5B depict context structures 500 and 520, in accordance with several embodiments. As an option, the present context structures 500 and 520 may be implemented in conjunction with features from any other embodiment listed herein, such as those described with reference to the other FIGS. Of course, however, such context structures 500 and 520 and others presented herein may be used in various applications and/or in permutations which may or may not be specifically described in the illustrative embodiments listed herein. Further, the context structures 500 and 520 presented herein may be used in any desired environment.

Referring first to FIG. 5A, the context structure 500 is a DOM tree list of context information elements, e.g., a business domain, a category, a component type, a hierarchy, a group, etc. The context structure 500 may be analyzed by a text element contextualized information constructor to collect the context information elements from a DOM tree element analysis module to build a context data structure, e.g., see FIG. 5B.

Referring now to FIG. 5B, the context structure 520 includes text contexts, e.g., see TC1, TC2, TC3 and TC4 that are extracted from the context structure 500. The elements of the context structure 520 provide context that may be used to contextually re-order text elements of a translation. For example, the elements of the context structure 520 may be applied as contextual input to the techniques described elsewhere herein, e.g., see method 200.

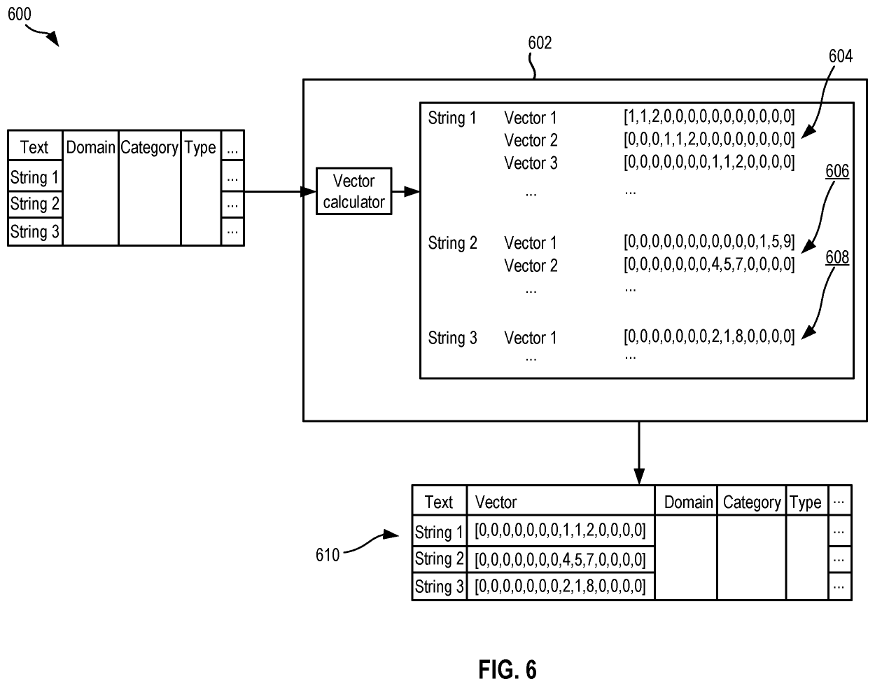

FIG. 6 depicts an I/O flowchart 600 for calculating word vectors with text element groupings and context information, in accordance with one embodiment. As an option, the present I/O flowchart 600 may be implemented in conjunction with features from any other embodiment listed herein, such as those described with reference to the other FIGS. Of course, however, such I/O flowchart 600 and others presented herein may be used in various applications and/or in permutations which may or may not be specifically described in the illustrative embodiments listed herein. Further, the I/O flowchart 600 presented herein may be used in any desired environment.

In some preferred approaches, the word vectors are calculated based on the grouping relationships of the text elements and the constructed context information. In some approaches, calculation of the word vectors includes inputting some strings in the same group with domain, category, type and other information in a predetermined type of vector calculator. For example, in FIG. 6, strings 1-3 are input into the “Vector calculator” of a word embeddings model 602. The I/O flowchart includes using the input strings to calculate vector candidate values for each string. For example, “String 1” is shown to include vector candidate values 604, “String 2” is shown to include vector candidate values 606, and “String 3” is shown to include vector candidate values 608, which may be calculated using techniques that would become apparent to one of ordinary skill in the art after reading the descriptions herein. Group vector values which have same dimension features may then be chosen, e.g., see output 610.

FIG. 7 depicts an I/O flowchart 700 for determining feature types of the text elements, in accordance with one embodiment. As an option, the present I/O flowchart 700 may be implemented in conjunction with features from any other embodiment listed herein, such as those described with reference to the other FIGS. Of course, however, such I/O flowchart 700 and others presented herein may be used in various applications and/or in permutations which may or may not be specifically described in the illustrative embodiments listed herein. Further, the I/O flowchart 700 presented herein may be used in any desired environment.

The I/O flowchart 700 includes inputting some strings (stings of words) in the same group with vector, domain, category, type and other information, e.g., see operation 702. The vectors may be input into a type of text feature type extractor that would become apparent to one of ordinary skill in the art after reading the descriptions herein, and the text feature type extractor may have access to a text feature type library. Furthermore, the text feature type extractor may be included in a text feature type extract model 704. The text feature type extractor may be configured to use the information to group the strings into different categories, e.g., based on the strings having at least a predetermined threshold degree of similarity with the category. A calculation may be performed to determine each string text feature candidate types, and a group text feature type may be chosen based on group domain, category, type and other information, e.g., see output of determination in operation 706.

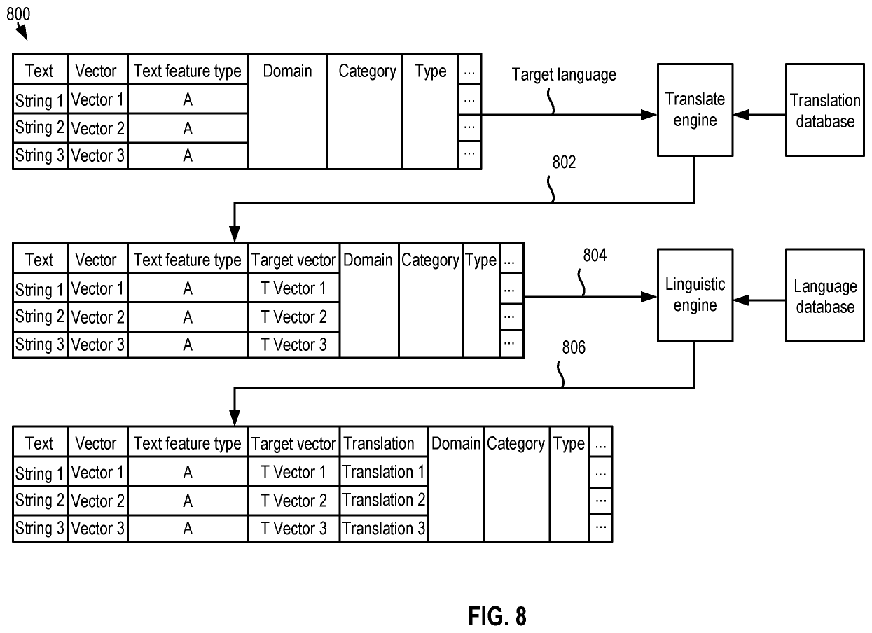

FIG. 8 depicts an I/O flowchart 800 for translating and re-ordering translated text elements, in accordance with one embodiment. As an option, the present I/O flowchart 800 may be implemented in conjunction with features from any other embodiment listed herein, such as those described with reference to the other FIGS. Of course, however, such I/O flowchart 800 and others presented herein may be used in various applications and/or in permutations which may or may not be specifically described in the illustrative embodiments listed herein. Further, the I/O flowchart 800 presented herein may be used in any desired environment.

The I/O flowchart 800 includes inputting strings of text elements of the same one of the grouping relationships into a predetermined translation engine, e.g., see Translate engine, which may have access to a predetermined translation database. In some approaches, the strings that are input may include matching information associated therewith, e.g., are in the same group, are in the vector, have a same text feature type, have other matching context information, etc. Furthermore, in some approaches, the strings may be input into the predetermined translation engine with the information, e.g., information about the word vectors, an indication of text feature types, and associated portions of the context information, etc. Outputs of the translation engine are input into a predetermined linguistic engine that may apply a predetermined set of predetermined rules of a language (target language) that the text elements are translated into, e.g., see operations 802-804. In some approaches, the outputs may include target vectors that are calculated for the strings of text elements. The predetermined linguistic engine is configured to incorporate and use the context, target translations for the strings of text elements, and re-order the strings of text elements, e.g., see operation 806.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining a domain and category information from metadata associated with a first webpage;
determining component types, hierarchies and grouping relationships for a plurality of text elements on the first webpage;
constructing context information for the text elements;
calculating, based on the grouping relationships and the context information, word vectors;
extracting, based on the word vectors and the context information, text feature types of the text elements; and
using the extracted text feature types to determine a re-ordering of a translation of the text elements.

2. The computer-implemented method of claim 1, comprising: training a predetermined translation model based on the context information to perform a context based re-ordering of translated text elements; and causing the trained translation model to perform a context based re-ordering of text elements translated from a second website.

3. The computer-implemented method of claim 1, wherein the domain and category information are determined by analyzing a predetermined target selected from the group consisting of: a uniform resource locator (URL), head information, and a navigator.

4. The computer-implemented method of claim 1, wherein the component types, hierarchies and grouping relationships are determined from the metadata associated with the first webpage, wherein the grouping relationships and context information are determined using a predetermined word embedding model.

5. The computer-implemented method of claim 1, wherein the context information is selected from the group consisting of: a business domain, a category, a component type, a parent and a group.

6. The computer-implemented method of claim 1, wherein using the extracted text feature types to determine a re-ordering of translations of the text elements includes: inputting strings of text elements of a same one of the grouping relationships into a predetermined translation engine, wherein the strings are input with: information about the word vectors, an indication of text feature types, and associated portions of the context information; obtaining outputs of the translation engine, wherein the outputs include target vectors for the strings of text elements; obtaining target translations for the strings of text elements; and re-ordering the strings of text elements according to the target translations.

7. The computer-implemented method of claim 1, wherein determining the component types, hierarchies and grouping relationships includes: retrieving text hierarchical relationships from a text tree; finding text groupings according to the text hierarchical relationships; performing special processing for at least some of the text elements; marking a sub-domain for each text group according to hierarchy and parent text; and marking a type for each of the text elements.

8. A computer program product, the computer program product comprising a computer readable storage medium having program instructions embodied therewith, the program instructions readable and/or executable by a computer to cause the computer to:
determine a domain and category information from metadata associated with a first webpage;
determine component types, hierarchies and grouping relationships for a plurality of text elements on the first webpage;
construct context information for the text elements;
calculate, based on the grouping relationships and the context information, word vectors;
extract, based on the word vectors and the context information, text feature types of the text elements; and
use the extracted text feature types to determine a re-ordering of a translation of the text elements.

9. The computer program product of claim 8, the program instructions readable and/or executable by the computer to cause the computer to: train a predetermined translation model based on the context information to perform a context based re-ordering of translated text elements; and cause the trained translation model to perform a context based re-ordering of text elements translated from a second website.

10. The computer program product of claim 8, wherein the domain and category information are determined by analyzing a predetermined target selected from the group consisting of: a uniform resource locator (URL), head information, and a navigator.

11. The computer program product of claim 8, wherein the component types, hierarchies and grouping relationships are determined from the metadata associated with the first webpage, wherein the grouping relationships and context information are determined using a predetermined word embedding model.

12. The computer program product of claim 8, wherein the context information is selected from the group consisting of: a business domain, a category, a component type, a parent and a group.

13. The computer program product of claim 8, wherein using the extracted text feature types to determine a re-ordering of translations of the text elements includes: inputting strings of text elements of a same one of the grouping relationships into a predetermined translation engine, wherein the strings are input with: information about the word vectors, an indication of text feature types, and associated portions of the context information; obtaining outputs of the translation engine, wherein the outputs include target vectors for the strings of text elements; obtaining target translations for the strings of text elements; and re-ordering the strings of text elements according to the target translations.

14. The computer program product of claim 8, wherein determining the component types, hierarchies and grouping relationships includes: retrieving text hierarchical relationships from a text tree; finding text groupings according to the text hierarchical relationships; performing special processing for at least some of the text elements; marking a sub-domain for each text group according to hierarchy and parent text; and marking a type for each of the text elements.

15. A system, comprising:
a processor; and
logic integrated with the processor, executable by the processor, or integrated with and executable by the processor, the logic being configured to:
determine a domain and category information from metadata associated with a first webpage;
determine component types, hierarchies and grouping relationships for a plurality of text elements on the first webpage;
construct context information for the text elements;
calculate, based on the grouping relationships and the context information, word vectors;
extract, based on the word vectors and the context information, text feature types of the text elements; and
use the extracted text feature types to determine a re-ordering of a translation of the text elements.

16. The system of claim 15, the logic being configured to: train a predetermined translation model based on the context information to perform a context based re-ordering of translated text elements; and cause the trained translation model to perform a context based re-ordering of text elements translated from a second website.

17. The system of claim 15, wherein the domain and category information are determined by analyzing a predetermined target selected from the group consisting of: a uniform resource locator (URL), head information, and a navigator.

18. The system of claim 15, wherein the component types, hierarchies and grouping relationships are determined from the metadata associated with the first webpage, wherein the grouping relationships and context information are determined using a predetermined word embedding model.

19. The system of claim 15, wherein the context information is selected from the group consisting of: a business domain, a category, a component type, a parent and a group.

20. The system of claim 15, wherein using the extracted text feature types to determine a re-ordering of translations of the text elements includes: inputting strings of text elements of a same one of the grouping relationships into a predetermined translation engine, wherein the strings are input with: information about the word vectors, an indication of text feature types, and associated portions of the context information; obtaining outputs of the translation engine, wherein the outputs include target vectors for the strings of text elements; obtaining target translations for the strings of text elements; and re-ordering the strings of text elements according to the target translations.
